(19) United States
(12) Patent Application Publication
(10) Pub. No.: US 2025/0001452 A1
(43) Pub. Date: Jan. 2, 2025

(54) BUILDING MATERIALS COMPRISING CARBON-DIOXIDE TREATED PAINTED ROOFING GRANULES

(71) Applicant: Specialty Granules Investments LLC, Parsippany, NJ (US)

(72) Inventors: Peter Wilson, Knoxville, MD (US); Jonathon MacBride, Greencastle, PA (US)

(21) Appl. No.: 18/755,802

(22) Filed: Jun. 27, 2024

Related U.S. Application Data
(60) Provisional application No. 63/510,381, filed on Jun. 27, 2023.

(51) Int. Cl. B05D 3/04; E04D 1/00

(52) U.S. Cl. CPC B05D 3/0453; E04D 1/00; B05D 2401/20; B05D 2601/20; E04D 2001/005

(57) ABSTRACT

Roofing granules comprising base particles coated with a paint composition and treated with carbon dioxide gas, and building materials, such as roofing shingles, that include such roofing granules. The roofing granules are prepared from base particles comprising rocks, minerals, and/or agglomerated inorganic material. The roofing granules are painted and thereafter cured by being exposed to carbon dioxide gas. The treatment with carbon dioxide gas results in a painted roofing granule that is resilient to weathering forces.

This application claims the priority of U.S. provisional application Ser. No. U.S. 63/510,381 entitled “Building Materials Comprising Carbon-Dioxide Treated Painted Roofing Granules” filed Jun. 27, 2023, which is incorporated herein by reference in its entirety for all purposes.

### FIELD OF THE INVENTION

The invention relates to building materials (such as roofing shingles) that include roofing granules comprising rocks, minerals, and/or agglomerated inorganic material. The invention also relates to roofing granules comprising rocks, minerals, and/or agglomerated inorganic material. According to embodiments described herein, the roofing granules are painted and thereafter cured by being exposed to carbon dioxide gas.

### BACKGROUND OF THE INVENTION

In order to withstand exterior weathering forces for long periods of time, silicate-based paints that are applied to roofing granules need to be cured and insolubilized. Traditionally, silicate-based paint is cured by mixing the silicate with clay, followed by heating the painted granule at temperatures that are typically around 900° F.

There is thus a need to cure painted roofing granules to provide resiliency to weathering forces, while removing the need to add clay and to heat the granules to high temperatures.

### SUMMARY OF THE INVENTION

One embodiment of this invention pertains to a method comprising: obtaining base particles; applying a paint composition to the base particles to produce painted base particles; and treating the painted base particles with carbon dioxide gas.

In one embodiment, the base particles comprise ceramic particles, mineral particles, rock particles, synthetic particles, agglomerated particles, or a combination thereof.

In one embodiment, the base particles are sintered.

In one embodiment, the base particles are unsintered.

In one embodiment, the treating of the painted base particles with carbon dioxide gas comprises placing the painted base particles in a chamber having a greater than atmospheric level of carbon dioxide gas.

In one embodiment, the greater than atmospheric level of carbon dioxide gas is from 5% to 100% by volume based on a total volume of the chamber. In one embodiment, the greater than atmospheric level of carbon dioxide gas is from 25% to 100% by volume based on a total volume of the chamber.

In one embodiment, the chamber comprises a reactor. In one embodiment, the reactor comprises one of a continuous flow reactor or a batch reactor.

In one embodiment, the treating of the painted base particles with carbon dioxide gas extends for a time period of from 1 minute to 120 minutes.

In one embodiment, the paint composition comprises water, one or more pigments, and sodium silicate. In one embodiment, the sodium silicate is water-soluble.

In one embodiment, the paint composition is free of clay.

In one embodiment, the paint composition is free of magnesium chloride.

In one embodiment, the applying of the paint composition to the base particles is conducted at a loading range of from 35 pounds/ton to 700 pounds/ton.

In one embodiment, the applying of the paint composition to the base particles is conducted a plurality of times to apply a plurality of coats of the paint composition to the base particles.

In one embodiment, the applying of the paint composition to the base particles is conducted at a temperature of 20° F. or less.

In one embodiment, the method further comprises drying the painted base particles.

In one embodiment, the method further comprises applying the painted base particles to a sheet to form a roofing material.

In one embodiment, the roofing material is a shingle or roll roofing.

Another embodiment of this invention pertains to a method comprising: obtaining (i) at least one of a rock, a mineral, or a combination thereof, and (ii) a binder; mixing (i) the at least one of a rock, a mineral, or a combination thereof and (ii) the binder to produce agglomerated particles; applying a paint composition to the agglomerated particles to produce painted agglomerated particles; and treating the painted agglomerated particles with carbon dioxide gas.

In one embodiment, the treating of the painted agglomerated particles with carbon dioxide gas comprises placing the painted agglomerated particles in a chamber having a greater than atmospheric level of carbon dioxide gas.

In one embodiment, the greater than atmospheric level of carbon dioxide gas is from 5% to 100% by volume based on a total volume of the chamber. In one embodiment, the greater than atmospheric level of carbon dioxide gas is from 25% to 100% by volume based on a total volume of the chamber.

In one embodiment, the chamber comprises a reactor. In one embodiment, the reactor comprises one of a continuous flow reactor or a batch reactor.

In one embodiment, the treating the painted agglomerated particles with carbon dioxide gas extends for a time period of from 1 minute to 120 minutes.

In one embodiment, the binder is added in an amount of 1 wt % to 15 wt % with respect to a total weight of the agglomerated particles. In another embodiment, the binder is added in an amount of about 5 wt % to 12 wt % with respect to a total weight of the agglomerated particles.

In one embodiment, the at least one of a rock, a mineral, or a combination thereof comprises one or more of basalt, metabasalt, andesite, granite, and rhyolite. In another embodiment, the at least one of a rock, a mineral, or a combination thereof comprises metabasalt.

In one embodiment, the binder is at least one of sodium silicate, gypsum, or a combination thereof.

In one embodiment, the binder comprises sodium silicate.

In one embodiment, the paint composition comprises water, one or more pigments, and sodium silicate. In one embodiment, the sodium silicate is water-soluble.

In one embodiment, the paint composition is free of clay.

In one embodiment, the paint composition is free of magnesium chloride.

In one embodiment, the applying of the paint composition to the agglomerated particles is conducted at a loading range of from 35 pounds/ton to 700 pounds/ton.

In one embodiment, the applying of the paint composition to the agglomerated particles is conducted a plurality of times to apply a plurality of coats of the paint composition to the agglomerated particles.

In one embodiment, the applying of the paint composition to the agglomerated particles is conducted at a temperature of 20° F. or less.

In one embodiment, the method further comprises drying the agglomerated particles. In another embodiment, the treating takes place after drying the agglomerated particles.

In one embodiment, the method further comprises applying the painted agglomerated particles to a sheet to form a roofing material.

In one embodiment, the roofing material is a shingle or roll roofing.

In one embodiment, the mixing of (i) the at least one of a rock, a mineral, or a combination thereof and (ii) the binder is conducted to produce unsintered agglomerated particles.

In one embodiment, the mixing uses a pin mixer.

In one embodiment, the method further comprises pelletizing the agglomerated particles.

In one embodiment, the at least one of a rock, a mineral, or a combination thereof have a particle size distribution comprising (1) at least about 10 wt % retained by US Mesh 50 after passing US Mesh 40, (2) at least about 5 wt % retained by US Mesh 60 after passing US Mesh 50, and (3) at least about 5 wt % retained by US Mesh 100 after passing US Mesh 60.

In another embodiment, the at least one of a rock, a mineral, or a combination thereof have a particle size distribution comprising (1) at least about 20 wt % retained by US Mesh 50 after passing US Mesh 40, (2) at least about 10 wt % retained by US Mesh 60 after passing US Mesh 50, and (3) at least about 10 wt % retained by US Mesh 100 after passing US Mesh 60.

In another embodiment, the at least one of a rock, a mineral, or a combination thereof have a particle size distribution comprising (1) at least about 10 wt % retained by US Mesh 100 after passing US Mesh 60, (2) at least about 10 wt % retained by US Mesh 200 after passing US Mesh 100, and (3) at least about 5 wt % retained by US Mesh 325 after passing US Mesh 200.

Another embodiment of this invention pertains to a roofing granule comprising one or more base particles; and a coating applied onto the one or more base particles, the coating comprising a paint composition, wherein the roofing granule is free of clay.

Another embodiment of this invention pertains to a roofing granule comprising one or more base particles; and a coating applied onto the one or more base particles, the coating comprising a paint composition, wherein the roofing granule is free of magnesium chloride.

Another embodiment of this invention pertains to a roofing granule comprising one or more base particles; and a coating applied onto the one or more base particles, the coating comprising a paint composition, wherein the roofing granule is at least one of (i) free of clay, (ii) free of magnesium chloride, or (iii) a combination of (i) and (ii).

Another embodiment of this invention pertains to a roofing granule comprising one or more base particles; and a coating applied onto the one or more base particles, the coating comprising a paint composition, wherein the roofing granule includes a percentage of sodium carbonate that is less than 1 wt % based on the total weight of the roofing granule.

In one embodiment, the base particles comprise ceramic particles, mineral particles, rock particles, synthetic particles, agglomerated particles, or a combination thereof.

In one embodiment, the base particles are sintered.

In one embodiment, the base particles are unsintered.

In one embodiment, the base particles have been treated with carbon dioxide gas. In an embodiment, the base particles are treated with carbon dioxide gas after the coating is applied onto the base particles.

In one embodiment, a binder is present in an amount of 1 wt % to 15 wt % with respect to a total weight of the base particles. In another embodiment, a binder is present in an amount of about 5 wt % to 12 wt % with respect to a total weight of the base particles.

In one embodiment, the base particles comprise agglomerated particles that comprise at least one of a rock, a mineral, or a combination thereof. In one embodiment, the least one of a rock, a mineral, or a combination thereof comprises one or more of basalt, metabasalt, andesite, granite, and rhyolite. In another embodiment, the at least one of a rock, a mineral, or a combination thereof comprises metabasalt.

In one embodiment, the agglomerated particles comprise a binder. In one embodiment, the binder is at least one of sodium silicate, gypsum, or a combination thereof. In one embodiment, the binder comprises sodium silicate.

In one embodiment, the paint composition comprises water, one or more pigments, and sodium silicate. In one embodiment, the sodium silicate is water-soluble.

In one embodiment, the roofing granule includes a percentage of sodium carbonate that is from 0 wt % to 0.5 wt % based on the total weight of the roofing granule.

Yet another embodiment of this invention pertains to a roofing material comprising coated base particles, the coated base particles having a coating comprising a paint composition, wherein the coated base particles are at least one of (i) free of clay, (ii) free of magnesium chloride, or (iii) a combination of (i) and (ii).

Another embodiment of this invention pertains to a roofing material comprising coated base particles, the coated base particles having a coating comprising a paint composition, wherein the coated base particles include a percentage of sodium carbonate that is less than 1 wt % based on the total weight of the coated base particles.

In one embodiment, the coated base particles comprise ceramic particles, mineral particles, rock particles, synthetic particles, agglomerated particles, or a combination thereof. In one embodiment, the coated base particles are sintered.

In one embodiment, the coated base particles are unsintered.

In one embodiment, the roofing material comprises a roofing shingle or roll roofing.

In one embodiment, the coated base particles have been treated with carbon dioxide gas.

In one embodiment, a binder is present in an amount of 1 wt % to 15 wt % with respect to a total weight of the coated base particles. In another embodiment, a binder is present in an amount of about 5 wt % to 12 wt % with respect to a total weight of the coated base particles.

In one embodiment, the coated base particles comprise agglomerated particles that comprise at least one of a rock, a mineral, or a combination thereof. In one embodiment, the least one of a rock, a mineral, or a combination thereof comprises one or more of basalt, metabasalt, andesite, granite, and rhyolite. In another embodiment, the at least one of a rock, a mineral, or a combination thereof comprises metabasalt.

In one embodiment, the agglomerated particles comprise a binder. In one embodiment, the binder is at least one of sodium silicate, gypsum, or a combination thereof. In one embodiment, the binder comprises sodium silicate.

In one embodiment, the paint composition comprises water, one or more pigments, and sodium silicate. In one embodiment, the sodium silicate is water-soluble.

In one embodiment, the coated base particles include a percentage of sodium carbonate that is from 0 wt % to 0.5 wt % based on the total weight of the coated base particles.

### DETAILED DESCRIPTION OF THE INVENTION

Among those benefits and improvements that have been disclosed, other objects and advantages of this disclosure will become apparent from the following description. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though they may. Furthermore, the phrases “in another embodiment” and “in some other embodiments” as used herein do not necessarily refer to a different embodiment, although they may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, terms such as “comprising,” “including,” and “having” do not limit the scope of a specific claim to the materials or steps recited by the claim.

As used herein, the term “consisting of” limits the scope of a specific claim to the materials and steps recited by the claim.

All prior patents, publications, and test methods referenced herein are incorporated by reference in their entireties.

As used herein, the term “weight percent” or “% by weight” means the percentage by weight of a component based upon a total weight of the base particles, the coated base particles, the agglomerated particles, the coated agglomerated particles, or the roofing granule, as applicable.

As used herein, the term “free of clay” means that the paint composition, the coated base particles, or the roofing granule, as applicable, is substantially free of clay, namely, less than 1% by weight of clay.

As used herein, the term “free of magnesium chloride” means that the paint composition, the coated base particles, or the roofing granule, as applicable, is substantially free of magnesium chloride, namely, less than 0.1% by weight of magnesium chloride.

As used herein, the terms “roofing material” or “roofing product” include, but are not limited to, shingles, roll roofing, roofing membranes, including, e.g., waterproofing membranes, and underlayment.

The present invention relates to the treatment of base particles and/or roofing granules with carbon dioxide gas to provide weather stability to a colored coating on the base particles and/or roofing granules, without the need for high temperature firing steps. In this regard, in order to withstand exterior weathering forces for long periods of time, silicate-based paints on roofing granules need to be cured and insolubilized. Prior to this invention, silicate-based paint has been cured by mixing the silicate with clay, followed by heating the painted granule at temperatures that are typically around 900° F. Thus, according to an aspect of the invention, base particles and/or roofing granules coated with a silicate-based paint can be cured by exposure to carbon dioxide gas resulting in a paint that is resilient against weathering forces. This removes the need to add clay to the paint mixture and to heat the base particles and/or roofing granules to a high temperature.

Besides the prior art colored roofing granules based on fired clay and silicate, alternative methods to cure silicate-based paints at low temperatures without the need to add clay have involved the post-treatment of roofing granules with a metal chloride and salt. However, these methods involve corrosive chemicals that, over time, can result in equipment wear and damage. Thus, according to another aspect of the invention, base particles and/or roofing granules coated with a silicate-based paint can be cured by exposure to carbon dioxide gas without the need to add clay and/or corrosive chemicals, such as, e.g., metal chloride and salt.

### A. BASE PARTICLES—COMPOSITION

In an embodiment, the roofing granules comprise base particles, including, e.g., ceramic particles, mineral particles, rock particles, synthetic particles, agglomerated particles, or a combination thereof.

According to an embodiment, ceramic particles include, e.g., granules of inorganic metal and non-metal, oxides, carbides, nitrides, or combinations thereof that have been formed into a sphere. These ceramic particles can be sintered, such that individual granules adhere to one another, thereby forming a sintered ceramic particle. In an embodiment, the ceramic particles do not include volatile components, such as binders or liquids used to make the base particle, nor any polymers or other coatings.

According to an embodiment, the base particles comprise ceramic particles, mineral particles, and/or rock particles of the type typically used in making roofing granules, such as, e.g., talc, slag, limestone, granite, syenite, diabase, greystone, slate, trap rock, basalt, greenstone, andesite, porphyry, rhyolite, or combinations thereof, or other naturally occurring metamorphic rocks, crushed ceramic particles, sands, gravels, or any similar types of particles.

According to an embodiment, the base particles include particles that are agglomerated. In an embodiment, the agglomerated particles comprise (i) a binder and (ii) an inorganic material. In an embodiment, the inorganic material comprises rock and/or mineral fragments (i.e., fragments of (a) rock and/or (b) mineral). In an embodiment, the rock and/or mineral fragments comprise fines and/or larger particle sizes.

In one embodiment, the rock and/or mineral fragments are of such a particle size as to pass US Mesh 40. In other embodiments, the rock and/or mineral fragments are of such a particle size as to pass US Mesh 50, or US Mesh 60, or US Mesh 70, or US Mesh 100, or US Mesh 120, or US Mesh 140, or US Mesh 200, or US Mesh 230, or US Mesh 270, or US Mesh 325. Ranges based on any of the foregoing are also contemplated, e.g., the rock and/or mineral fragments may have particle sizes passing US Mesh 40 but retained by US Mesh 325.

A non-limiting example of the binder includes sodium silicate. According to one embodiment, the binder is at least one of sodium silicate, gypsum, or a combination thereof.

Non-limiting examples of rock and/or mineral materials include igneous rocks such as basalt, andesite, granite, and rhyolite, amphibolite produced from the metamorphism of the basalt parent such as metabasalt, or combinations thereof—e.g., basalt and metabasalt; basalt and andesite.

In an embodiment, the content of the binder in the base particles and/or agglomerated particles is at least about 1 wt %, at least about 2 wt %, at least about 3 wt %, at least about 5 wt %, at least about 6 wt %, at least about 10 wt %, at least about 12 wt %, at least about 13 wt %, at least about 14 wt %, or at least about 15 wt %.

In an embodiment, the content of the binder in the base particles and/or agglomerated particles is from about 1 wt % to about 15 wt %. In an embodiment, the content of the binder in the base particles and/or agglomerated particles is from about 2 wt % to about 15 wt %. In an embodiment, the content of the binder in the base particles and/or agglomerated particles is from about 3 wt % to about 15 wt %. In an embodiment, the content of the binder in the base particles and/or agglomerated particles is from about 4 wt % to about 15 wt %. In an embodiment, the content of the binder in the base particles and/or agglomerated particles is from about 5 wt % to about 15 wt %. In an embodiment, the content of the binder in the base particles and/or agglomerated particles is from about 6 wt % to about 15 wt %. In an embodiment, the content of the binder in the base particles and/or agglomerated particles is from about 7 wt % to about 15 wt %. In an embodiment, the content of the binder in the base particles and/or agglomerated particles is from about 8 wt % to about 15 wt %. In an embodiment, the content of the binder in the base particles and/or agglomerated particles is from about 9 wt % to about 15 wt %. In an embodiment, the content of the binder in the base particles and/or agglomerated particles is from about 10 wt % to about 15 wt %. In an embodiment, the content of the binder in the base particles and/or agglomerated particles is from about 11 wt % to about 15 wt %. In an embodiment, the content of the binder in the base particles and/or agglomerated particles is from about 12 wt % to about 15 wt %. In an embodiment, the content of the binder in the base particles and/or agglomerated particles is from about 13 wt % to about 15 wt %. In an embodiment, the content of the binder in the base particles and/or agglomerated particles is from about 14 wt % to about 15 wt %.

In an embodiment, the content of the binder in the base particles and/or agglomerated particles is from about 1 wt % to about 14 wt %. In an embodiment, the content of the binder in the base particles and/or agglomerated particles is from about 2 wt % to about 14 wt %. In an embodiment, the content of the binder in the base particles and/or agglomerated particles is from about 3 wt % to about 14 wt %. In an embodiment, the content of the binder in the base particles and/or agglomerated particles is from about 4 wt % to about 14 wt %. In an embodiment, the content of the binder in the base particles and/or agglomerated particles is from about 5 wt % to about 14 wt %. In an embodiment, the content of the binder in the base particles and/or agglomerated particles is from about 6 wt % to about 14 wt %. In an embodiment, the content of the binder in the base particles and/or agglomerated particles is from about 7 wt % to about 14 wt %. In an embodiment, the content of the binder in the base particles and/or agglomerated particles is from about 8 wt % to about 14 wt %. In an embodiment, the content of the binder in the base particles and/or agglomerated particles is from about 9 wt % to about 14 wt %. In an embodiment, the content of the binder in the base particles and/or agglomerated particles is from about 10 wt % to about 14 wt %. In an embodiment, the content of the binder in the base particles and/or agglomerated particles is from about 11 wt % to about 14 wt %. In an embodiment, the content of the binder in the base particles and/or agglomerated particles is from about 12 wt % to about 14 wt %. In an embodiment, the content of the binder in the base particles and/or agglomerated particles is from about 13 wt % to about 14 wt %.

In an embodiment, the content of the binder in the base particles and/or agglomerated particles is from about 1 wt % to about 13 wt %. In an embodiment, the content of the binder in the base particles and/or agglomerated particles is from about 2 wt % to about 13 wt %. In an embodiment, the content of the binder in the base particles and/or agglomerated particles is from about 3 wt % to about 13 wt %. In an embodiment, the content of the binder in the base particles and/or agglomerated particles is from about 4 wt % to about 13 wt %. In an embodiment, the content of the binder in the base particles and/or agglomerated particles is from about 5 wt % to about 13 wt %. In an embodiment, the content of the binder in the base particles and/or agglomerated particles is from about 6 wt % to about 13 wt %. In an embodiment, the content of the binder in the base particles and/or agglomerated particles is from about 7 wt % to about 13 wt %. In an embodiment, the content of the binder in the base particles and/or agglomerated particles is from about 8 wt % to about 13 wt %. In an embodiment, the content of the binder in the base particles and/or agglomerated particles is from about 9 wt % to about 13 wt %. In an embodiment, the content of the binder in the base particles and/or agglomerated particles is from about 10 wt % to about 13 wt %. In an embodiment, the content of the binder in the base particles and/or agglomerated particles is from about 11 wt % to about 13 wt %. In an embodiment, the content of the binder in the base particles and/or agglomerated particles is from about 12 wt % to about 13 wt %.

In an embodiment, the content of the binder in the base particles and/or agglomerated particles is from about 1 wt % to about 12 wt %. In an embodiment, the content of the binder in the base particles and/or agglomerated particles is from about 2 wt % to about 12 wt %. In an embodiment, the content of the binder in the base particles and/or agglomerated particles is from about 3 wt % to about 12 wt %. In an embodiment, the content of the binder in the base particles and/or agglomerated particles is from about 4 wt % to about 12 wt %. In an embodiment, the content of the binder in the base particles and/or agglomerated particles is from about 5 wt % to about 12 wt %. In an embodiment, the content of the binder in the base particles and/or agglomerated particles is from about 6 wt % to about 12 wt %. In an embodiment, the content of the binder in the base particles and/or agglomerated particles is from about 7 wt % to about 12 wt %. In an embodiment, the content of the binder in the base particles and/or agglomerated particles is from about 8 wt % to about 12 wt %. In an embodiment, the content of the binder in the base particles and/or agglomerated particles is from about 9 wt % to about 12 wt %. In an embodiment, the content of the binder in the base particles and/or agglomerated particles is from about 10 wt % to about 12 wt %. In an embodiment, the content of the binder in the base particles and/or agglomerated particles is from about 11 wt % to about 12 wt %.

In an embodiment, the content of the binder in the base particles and/or agglomerated particles is about 12 wt %. In an embodiment, the content of the binder in the base particles and/or agglomerated particles is about 13 wt %. In an embodiment, the content of the binder in the base particles and/or agglomerated particles is about 13.5 wt %. In an embodiment, the content of the binder in the base particles and/or agglomerated particles is about 14 wt %.

In embodiments, the base particles and/or agglomerated particles comprise the content of the binder of any of the embodiments detailed herein with the rock and/or mineral fragments forming the remainder.

In an embodiment, a coating is applied onto the base particles, with the coating comprising a paint composition. In an embodiment, the paint composition comprises water, one or more pigments, and sodium silicate. In one embodiment, the sodium silicate is water-soluble. In an embodiment, the coating provides color to the base particles. In an embodiment, coated base particles are applied to the buttlap of a roofing shingle.

In one embodiment, the base particles, including the coated base particles discussed above, have been treated with carbon dioxide gas, as discussed further below.

In one embodiment, the base particles are sintered.

In one embodiment, the base particles are unsintered.

In one embodiment, the base particles (or roofing granules), including the coated base particles discussed above, are free of clay.

In one embodiment, the base particles (or roofing granules), including the coated base particles discussed above, are free of magnesium chloride.

In one embodiment, the base particles (or roofing granules), including the coated base particles discussed above, are at least one of (i) free of clay, (ii) free of magnesium chloride, or (iii) a combination of (i) and (ii).

In one embodiment, the base particles (or roofing granules), including the coated base particles discussed above, include a percentage of sodium carbonate that is less than 1 wt % based on the total weight of the base particles (or roofing granules). In one embodiment, the base particles (or roofing granules), including the coated base particles discussed above, include a percentage of sodium carbonate that is from 0 wt % to 0.5 wt % based on the total weight of the base particles (or roofing granules).

In one embodiment, the base particles (or roofing granules) of the present disclosure, including the coated base particles discussed above, have a lower alkalinity number and thereby a more stable coating as compared to, e.g., (i) traditional roofing granules coated with a silicate-based paint that has been cured by mixing the silicate with clay, followed by heating the painted granule at temperatures that are typically around 900° F., and/or (ii) traditional roofing granules having a post-treatment with a metal chloride and salt.

In one embodiment, the roofing granules consist essentially of, or consist of, (a) base particles and (b) the coating that comprises a paint composition.

In one embodiment, the base particles comprise agglomerated particles that consist essentially of, or consist of, (a) the rock and/or mineral fragments and (b) the binder, or (a) the rock and/or mineral fragments, (b) the binder, and (c) the coating that comprises a paint composition.

In an embodiment, the base particles comprise agglomerated particles that have a particle size distribution. In an embodiment, the particle size distribution is monomodal, bimodal or multimodal. That is, the agglomerated particles may have one, two or multiple modal sizes.

In an embodiment, the particle size distribution of the agglomerated particles applied, e.g., to the back surface of a roofing shingle comprises at least about 10 wt % particles of US Mesh 50, at least about 20 wt % particles of US Mesh 50, at least about 30 wt % particles of US Mesh 50, or at least about 40 wt % particles of US Mesh 50. In an embodiment, the particle size distribution of the agglomerated particles applied to the back surface of the shingle comprises at least about 5 wt % particles of US Mesh 60, at least about 10 wt % particles of US Mesh 60, at least about 20 wt % particles of US Mesh 60, or at least about 30 wt % particles of US Mesh 60. In an embodiment, the particle size distribution of the agglomerated particles applied to the back surface of the shingle comprises at least about 5 wt % particles of US Mesh 100, at least about 10 wt % particles of US Mesh 100, at least about 20 wt % particles of US Mesh 100, or at least about 30 wt % particles of US Mesh 100.

In another embodiment, the particle size distribution of the agglomerated particles applied to, e.g., the headlap of a roofing shingle comprises at least about 1 wt % particles of US Mesh 200, at least about 2 wt % particles of US Mesh 200, at least about 5 wt % particles of US Mesh 200, at least about 10 wt % particles of US Mesh 200, at least about 20 wt % particles of US Mesh 200, or at least at least about 30 wt % particles of US Mesh 200. In an embodiment, the particle size distribution of the agglomerated particles applied to the headlap of the shingle comprises at least about 1 wt % particles of US Mesh 325, at least about 2 wt % particles of US Mesh 325, at least about 5 wt % particles of US Mesh 325, at least about 10 wt % particles of US Mesh 325, at least about 20 wt % particles of US Mesh 325, or at least at least about 30 wt % particles of US Mesh 325.

In another embodiment, the particle size distribution of the agglomerated particles applied, e.g., to the headlap of a roofing shingle comprises at least about 1 wt % particles of US Mesh 20, at least about 2 wt % particles of US Mesh 20, at least about 5 wt % particles of US Mesh 20, at least about 10 wt % particles of US Mesh 20, at least about 20 wt % particles of US Mesh 20, or at least at least about 30 wt % particles of US Mesh 20. In an embodiment, the particle size distribution of the agglomerated particles applied to the headlap of the shingle comprises at least about 40 wt % particles of US Mesh 30, at least about 50 wt % particles of US Mesh 30, at least about 60 wt % particles of US Mesh 30, at least about 70 wt % particles of US Mesh 30, or at least about 80 wt % particles of US Mesh 30. In an embodiment, the particle size distribution of the agglomerated particles applied to the headlap of the shingle comprises at least about 2 wt % particles of US Mesh 40, at least about 4 wt % particles of US Mesh 40, at least about 10 wt % particles of US Mesh 40, at least about 20 wt % particles of US Mesh 40, at least about 30 wt % particles of US Mesh 40, or at least about 40 wt % particles of US Mesh 40.

### B. METHOD OF TREATING BASE PARTICLES

One embodiment of this invention pertains to a method of treating base particles that can be applied to, e.g., roofing materials (e.g., roofing shingles). In an embodiment, the method includes obtaining base particles (e.g., ceramic particles, mineral particles, rock particles, synthetic particles, agglomerated particles, or a combination thereof), applying a paint composition to the base particles to produce painted base particles, and treating the painted base particles with carbon dioxide gas.

According to an embodiment, once the base particles are obtained, a paint composition is applied to the base particles to produce painted base particles. In one embodiment, the paint composition comprises water, one or more pigments, and sodium silicate. In one embodiment, the sodium silicate is water-soluble. In one embodiment, the paint composition is free of clay. In one embodiment, the paint composition is free of magnesium chloride.

In one embodiment, the applying of the paint composition to the base particles is conducted at a loading range of from 35 pounds/ton to 700 pounds/ton. In one embodiment, the applying of the paint composition to the base particles is conducted at a loading range of from 50 pounds/ton to 700 pounds/ton. In one embodiment, the applying of the paint composition to the base particles is conducted at a loading range of from 75 pounds/ton to 700 pounds/ton. In one embodiment, the applying of the paint composition to the base particles is conducted at a loading range of from 100 pounds/ton to 700 pounds/ton. In one embodiment, the applying of the paint composition to the base particles is conducted at a loading range of from 150 pounds/ton to 700 pounds/ton. In one embodiment, the applying of the paint composition to the base particles is conducted at a loading range of from 200 pounds/ton to 700 pounds/ton. In one embodiment, the applying of the paint composition to the base particles is conducted at a loading range of from 250 pounds/ton to 700 pounds/ton. In one embodiment, the applying of the paint composition to the base particles is conducted at a loading range of from 300 pounds/ton to 700 pounds/ton. In one embodiment, the applying of the paint composition to the base particles is conducted at a loading range of from 350 pounds/ton to 700 pounds/ton. In one embodiment, the applying of the paint composition to the base particles is conducted at a loading range of from 400 pounds/ton to 700 pounds/ton. In one embodiment, the applying of the paint composition to the base particles is conducted at a loading range of from 450 pounds/ton to 700 pounds/ton. In one embodiment, the applying of the paint composition to the base particles is conducted at a loading range of from 500 pounds/ton to 700 pounds/ton. In one embodiment, the applying of the paint composition to the base particles is conducted at a loading range of from 550 pounds/ton to 700 pounds/ton. In one embodiment, the applying of the paint composition to the base particles is conducted at a loading range of from 600 pounds/ton to 700 pounds/ton. In one embodiment, the applying of the paint composition to the base particles is conducted at a loading range of from 650 pounds/ton to 700 pounds/ton.

In one embodiment, the applying of the paint composition to the base particles is conducted at a loading range of from 35 pounds/ton to 500 pounds/ton. In one embodiment, the applying of the paint composition to the base particles is conducted at a loading range of from 50 pounds/ton to 500 pounds/ton. In one embodiment, the applying of the paint composition to the base particles is conducted at a loading range of from 75 pounds/ton to 500 pounds/ton. In one embodiment, the applying of the paint composition to the base particles is conducted at a loading range of from 100 pounds/ton to 500 pounds/ton. In one embodiment, the applying of the paint composition to the base particles is conducted at a loading range of from 150 pounds/ton to 500 pounds/ton. In one embodiment, the applying of the paint composition to the base particles is conducted at a loading range of from 200 pounds/ton to 500 pounds/ton. In one embodiment, the applying of the paint composition to the base particles is conducted at a loading range of from 250 pounds/ton to 500 pounds/ton. In one embodiment, the applying of the paint composition to the base particles is conducted at a loading range of from 300 pounds/ton to 500 pounds/ton. In one embodiment, the applying of the paint composition to the base particles is conducted at a loading range of from 350 pounds/ton to 500 pounds/ton. In one embodiment, the applying of the paint composition to the base particles is conducted at a loading range of from 400 pounds/ton to 500 pounds/ton. In one embodiment, the applying of the paint composition to the base particles is conducted at a loading range of from 450 pounds/ton to 500 pounds/ton.

In one embodiment, the applying of the paint composition to the base particles is conducted at a loading range of from 35 pounds/ton to 300 pounds/ton. In one embodiment, the applying of the paint composition to the base particles is conducted at a loading range of from 50 pounds/ton to 300 pounds/ton. In one embodiment, the applying of the paint composition to the base particles is conducted at a loading range of from 75 pounds/ton to 300 pounds/ton. In one embodiment, the applying of the paint composition to the base particles is conducted at a loading range of from 100 pounds/ton to 300 pounds/ton. In one embodiment, the applying of the paint composition to the base particles is conducted at a loading range of from 150 pounds/ton to 300 pounds/ton. In one embodiment, the applying of the paint composition to the base particles is conducted at a loading range of from 200 pounds/ton to 300 pounds/ton. In one embodiment, the applying of the paint composition to the base particles is conducted at a loading range of from 250 pounds/ton to 300 pounds/ton.

In one embodiment, the applying of the paint composition to the base particles is conducted at a loading range of from 35 pounds/ton to 200 pounds/ton. In one embodiment, the applying of the paint composition to the base particles is conducted at a loading range of from 50 pounds/ton to 200 pounds/ton. In one embodiment, the applying of the paint composition to the base particles is conducted at a loading range of from 75 pounds/ton to 200 pounds/ton. In one embodiment, the applying of the paint composition to the base particles is conducted at a loading range of from 100 pounds/ton to 200 pounds/ton. In one embodiment, the applying of the paint composition to the base particles is conducted at a loading range of from 150 pounds/ton to 200 pounds/ton.

In one embodiment, the applying of the paint composition to the base particles is conducted at a loading range of from 35 pounds/ton to 100 pounds/ton. In one embodiment, the applying of the paint composition to the base particles is conducted at a loading range of from 50 pounds/ton to 100 pounds/ton. In one embodiment, the applying of the paint composition to the base particles is conducted at a loading range of from 75 pounds/ton to 100 pounds/ton. In one embodiment, the applying of the paint composition to the base particles is conducted at a loading range of from 35 pounds/ton to 75 pounds/ton. In one embodiment, the applying of the paint composition to the base particles is conducted at a loading range of from 50 pounds/ton to 75 pounds/ton. In one embodiment, the applying of the paint composition to the base particles is conducted at a loading range of from 35 pounds/ton to 50 pounds/ton.

In one embodiment, the applying of the paint composition to the base particles is conducted a plurality of times to apply a plurality of coats of the paint composition to the base particles. In one embodiment, the applying of the paint composition to the base particles is conducted two times to apply two coats of the paint composition to the base particles. In one embodiment, the applying of the paint composition to the base particles is conducted three times to apply three coats of the paint composition to the base particles. In one embodiment, the applying of the paint composition to the base particles is conducted four times to apply four coats of the paint composition to the base particles. In one embodiment, the applying of the paint composition to the base particles is conducted five times to apply five coats of the paint composition to the base particles. In one embodiment, the applying of the paint composition to the base particles is conducted six times to apply six coats of the paint composition to the base particles. In one embodiment, the applying of the paint composition to the base particles is conducted seven times to apply seven coats of the paint composition to the base particles. In one embodiment, the applying of the paint composition to the base particles is conducted eight times to apply eight coats of the paint composition to the base particles. In one embodiment, the applying of the paint composition to the base particles is conducted nine times to apply nine coats of the paint composition to the base particles. In one embodiment, the applying of the paint composition to the base particles is conducted ten times to apply ten coats of the paint composition to the base particles. While the embodiments described herein include applying the paint composition to the base particles up to ten times to apply up to ten coats of the paint composition to the base particles, the amount of applications of the paint composition and the number of coats of the paint composition applied to the base particles are not limited and can include any number possible.

In one embodiment, the applying of the paint composition to the base particles is conducted at low temperatures compared with conventional firing methods. In one embodiment, the applying of the paint composition to the base particles is conducted at a temperature of 20° F. or less.

According to one embodiment, once the paint composition is applied to the base particles to produce painted base particles, the painted base particles are treated (or cured) with carbon dioxide gas.

In one embodiment, the treating of the painted base particles with carbon dioxide gas comprises placing the painted base particles in a chamber having a greater than atmospheric level of carbon dioxide gas. In one embodiment, the chamber comprises a reactor. In one embodiment, the reactor comprises one of a continuous flow reactor or a batch reactor.

In one embodiment, the greater than atmospheric level of carbon dioxide gas is from 5% to 100% by volume based on a total volume of the chamber. In one embodiment, the greater than atmospheric level of carbon dioxide gas is from 10% to 100% by volume based on a total volume of the chamber. In one embodiment, the greater than atmospheric level of carbon dioxide gas is from 25% to 100% by volume based on a total volume of the chamber. In one embodiment, the greater than atmospheric level of carbon dioxide gas is from 35% to 100% by volume based on a total volume of the chamber. In one embodiment, the greater than atmospheric level of carbon dioxide gas is from 50% to 100% by volume based on a total volume of the chamber. In one embodiment, the greater than atmospheric level of carbon dioxide gas is from 75% to 100% by volume based on a total volume of the chamber. In one embodiment, the greater than atmospheric level of carbon dioxide gas is from 5% to 75% by volume based on a total volume of the chamber. In one embodiment, the greater than atmospheric level of carbon dioxide gas is from 10% to 75% by volume based on a total volume of the chamber. In one embodiment, the greater than atmospheric level of carbon dioxide gas is from 25% to 75% by volume based on a total volume of the chamber. In one embodiment, the greater than atmospheric level of carbon dioxide gas is from 35% to 75% by volume based on a total volume of the chamber. In one embodiment, the greater than atmospheric level of carbon dioxide gas is from 50% to 75% by volume based on a total volume of the chamber. In one embodiment, the greater than atmospheric level of carbon dioxide gas is from 5% to 50% by volume based on a total volume of the chamber. In one embodiment, the greater than atmospheric level of carbon dioxide gas is from 10% to 50% by volume based on a total volume of the chamber. In one embodiment, the greater than atmospheric level of carbon dioxide gas is from 25% to 50% by volume based on a total volume of the chamber. In one embodiment, the greater than atmospheric level of carbon dioxide gas is from 35% to 50% by volume based on a total volume of the chamber. In one embodiment, the greater than atmospheric level of carbon dioxide gas is from 5% to 35% by volume based on a total volume of the chamber. In one embodiment, the greater than atmospheric level of carbon dioxide gas is from 10% to 35% by volume based on a total volume of the chamber. In one embodiment, the greater than atmospheric level of carbon dioxide gas is from 25% to 35% by volume based on a total volume of the chamber. In one embodiment, the greater than atmospheric level of carbon dioxide gas is from 5% to 25% by volume based on a total volume of the chamber. In one embodiment, the greater than atmospheric level of carbon dioxide gas is from 10% to 25% by volume based on a total volume of the chamber. In one embodiment, the greater than atmospheric level of carbon dioxide gas is from 5% to 10% by volume based on a total volume of the chamber.

In one embodiment, the treating the painted base particles with carbon dioxide gas extends for a time period of from 1 minute to 120 minutes. In one embodiment, the treating the painted base particles with carbon dioxide gas extends for a time period of from 1 minute to 100 minutes. In one embodiment, the treating the painted base particles with carbon dioxide gas extends for a time period of from 1 minute to 90 minutes. In one embodiment, the treating the painted base particles with carbon dioxide gas extends for a time period of from 1 minute to 75 minutes. In one embodiment, the treating the painted base particles with carbon dioxide gas extends for a time period of from 1 minute to 60 minutes. In one embodiment, the treating the painted base particles with carbon dioxide gas extends for a time period of from 1 minute to 45 minutes. In one embodiment, the treating the painted base particles with carbon dioxide gas extends for a time period of from 1 minute to 30 minutes. In one embodiment, the treating the painted base particles with carbon dioxide gas extends for a time period of from 1 minute to 10 minutes. In one embodiment, the treating the painted base particles with carbon dioxide gas extends for a time period of from 1 minute to 5 minutes. In one embodiment, the treating the painted base particles with carbon dioxide gas extends for a time period of from 5 minutes to 120 minutes. In one embodiment, the treating the painted base particles with carbon dioxide gas extends for a time period of from 5 minutes to 100 minutes. In one embodiment, the treating the painted base particles with carbon dioxide gas extends for a time period of from 5 minutes to 90 minutes. In one embodiment, the treating the painted base particles with carbon dioxide gas extends for a time period of from 5 minutes to 75 minutes. In one embodiment, the treating the painted base particles with carbon dioxide gas extends for a time period of from 5 minutes to 60 minutes. In one embodiment, the treating the painted base particles with carbon dioxide gas extends for a time period of from 5 minutes to 45 minutes. In one embodiment, the treating the painted base particles with carbon dioxide gas extends for a time period of from 5 minutes to 30 minutes. In one embodiment, the treating the painted base particles with carbon dioxide gas extends for a time period of from 5 minutes to 10 minutes. In one embodiment, the treating the painted base particles with carbon dioxide gas extends for a time period of from 10 minutes to 120 minutes. In one embodiment, the treating the painted base particles with carbon dioxide gas extends for a time period of from 10 minutes to 100 minutes. In one embodiment, the treating the painted base particles with carbon dioxide gas extends for a time period of from 10 minutes to 90 minutes. In one embodiment, the treating the painted base particles with carbon dioxide gas extends for a time period of from 10 minutes to 75 minutes. In one embodiment, the treating the painted base particles with carbon dioxide gas extends for a time period of from 10 minutes to 60 minutes. In one embodiment, the treating the painted base particles with carbon dioxide gas extends for a time period of from 10 minutes to 45 minutes. In one embodiment, the treating the painted base particles with carbon dioxide gas extends for a time period of from 10 minutes to 30 minutes. In one embodiment, the treating the painted base particles with carbon dioxide gas extends for a time period of from 30 minutes to 120 minutes. In one embodiment, the treating the painted base particles with carbon dioxide gas extends for a time period of from 30 minutes to 100 minutes. In one embodiment, the treating the painted base particles with carbon dioxide gas extends for a time period of from 30 minutes to 90 minutes. In one embodiment, the treating the painted base particles with carbon dioxide gas extends for a time period of from 30 minutes to 75 minutes. In one embodiment, the treating the painted base particles with carbon dioxide gas extends for a time period of from 30 minutes to 60 minutes. In one embodiment, the treating the painted base particles with carbon dioxide gas extends for a time period of from 30 minutes to 45 minutes. In one embodiment, the treating the painted base particles with carbon dioxide gas extends for a time period of from 45 minutes to 120 minutes. In one embodiment, the treating the painted base particles with carbon dioxide gas extends for a time period of from 45 minutes to 100 minutes. In one embodiment, the treating the painted base particles with carbon dioxide gas extends for a time period of from 45 minutes to 90 minutes. In one embodiment, the treating the painted base particles with carbon dioxide gas extends for a time period of from 45 minutes to 75 minutes. In one embodiment, the treating the painted base particles with carbon dioxide gas extends for a time period of from 45 minutes to 60 minutes. In one embodiment, the treating the painted base particles with carbon dioxide gas extends for a time period of from 60 minutes to 120 minutes. In one embodiment, the treating the painted base particles with carbon dioxide gas extends for a time period of from 60 minutes to 100 minutes. In one embodiment, the treating the painted base particles with carbon dioxide gas extends for a time period of from 60 minutes to 90 minutes. In one embodiment, the treating the painted base particles with carbon dioxide gas extends for a time period of from 60 minutes to 75 minutes. In one embodiment, the treating the painted base particles with carbon dioxide gas extends for a time period of from 75 minutes to 120 minutes. In one embodiment, the treating the painted base particles with carbon dioxide gas extends for a time period of from 75 minutes to 100 minutes. In one embodiment, the treating the painted base particles with carbon dioxide gas extends for a time period of from 75 minutes to 90 minutes. In one embodiment, the treating the painted base particles with carbon dioxide gas extends for a time period of from 90 minutes to 120 minutes. In one embodiment, the treating the painted base particles with carbon dioxide gas extends for a time period of from 90 minutes to 100 minutes. In one embodiment, the treating the painted base particles with carbon dioxide gas extends for a time period of from 100 minutes to 120 minutes.

In one embodiment, the method further comprises drying the base particles. In another embodiment, the treating with carbon dioxide gas takes place after drying the base particles.

In one embodiment, the method further comprises applying the painted base particles to a sheet to form a roofing product, as discussed further below.

Another embodiment of this invention pertains to a method of making and treating base particles that comprise agglomerated particles, including coated agglomerated particles, that can be applied to, e.g., roofing materials (e.g., roofing shingles). In an embodiment, rock and/or mineral fragments, as well as a binder (e.g., a liquid binder), are obtained. In an embodiment, the rock and/or mineral fragments are combined (or mixed) with the liquid binder in, e.g., a pin mixer to produce agglomerated particles. In the pin mixer, pins or rods attached to a horizontal spinning shaft mix the components and produce agglomerated particles by the action of centrifugal force. In an embodiment, the volume of the binder is typically between 1-5 wt % based on the total mass of the dry material at this step. In an embodiment, the agglomerated particles produced by the pin mixer are substantially spherical. In an embodiment, the agglomerated particles produced by the pin mixer may be dried and used directly. Agglomerated particles made by the pin mixer may be applied to the back surface or headlap of a roofing material (e.g., a roofing shingle).

In one embodiment, the mixing of (i) the at least one of a rock, a mineral, or a combination thereof and (ii) the binder is conducted to produce unsintered agglomerated particles.

In another embodiment, once the material is mixed in the pix mixer, the agglomerated particles produced by the pin mixer are combined with further liquid binder in a disc or pan pelletizer. The agglomerated particles produced by the pin mixer are fed into the disk/pan pelletizer where the binder is added to encourage pelletization. According to one embodiment, the volume of the binder at this step is typically between 5-12 wt % based on the mass of the total dry mass. The agglomerated particle size is increased by the actions of tumble growth and centrifugal force. The agglomerated particle size may be controlled by varying the disc angle and speed of rotation, and by modulating the properties of the input particles and liquid binder. Once the desired agglomerated particle size is achieved, the agglomerated particles may be dried (e.g., in an oven or a fluidized bed dryer). The disc or pan pelletizer increases the agglomerated particle size and produces agglomerated particles that may be applied to the front surface buttlap of a roofing shingle. In an embodiment, the agglomerated particles are dried after leaving the pin mixer, or disc or pan pelletizer. In an embodiment, the agglomerated particles are dried in a fluid bed drying system. In the fluid bed drying system, hot air flows through a perforated plate that both dries the agglomerated particles and moves the agglomerated particles through the apparatus. In an embodiment, the fluid bed drying system comprises multiple heating zones and a final cooling zone.

According to one embodiment, the overall amount of the binder in the process described above is typically 13 wt % based on the total dry mass. However, the overall amount of the binder in the process can include any of the various amounts of binder described above.

According to an embodiment, once the agglomerated particles are obtained and/or prepared, a paint composition is applied to the agglomerated particles to produce painted agglomerated particles according to the embodiments described above. According to another embodiment, after applying the paint composition to the agglomerated particles to produce painted agglomerated particles, the painted agglomerated particles are treated with carbon dioxide gas according to the embodiments described above.

In one embodiment, the method further comprises drying the agglomerated particles. In another embodiment, the treating with carbon dioxide gas takes place after drying the agglomerated particles.

In one embodiment, the method further comprises applying the painted agglomerated particles to a sheet to form a roofing product, as discussed further below.

### C. ROOFING GRANULES, ROOFING MATERIALS, AND/OR METHODS OF APPLYING THE BASE PARTICLES TO A ROOFING MATERIAL

Another embodiment of this inventions pertains to roofing granules comprised of base particles, including the above-discussed painted or coated base materials. According to one embodiment, the roofing granules comprise one or more base particles, and a coating applied onto the one or more base particles, the coating comprising a paint composition, wherein the roofing granule is free of clay. According to another embodiment, the roofing granules comprise one or more base particles, and a coating applied onto the one or more base particles, the coating comprising a paint composition, wherein the roofing granule is free of magnesium chloride. According to another embodiment, the roofing granules comprise one or more base particles, and a coating applied onto the one or more base particles, the coating comprising a paint composition, wherein the roofing granule is at least one of (i) free of clay, (ii) free of magnesium chloride, or (iii) a combination of (i) and (ii). According to yet another embodiment, the roofing granules comprise one or more base particles, and a coating applied onto the one or more particles, the coating comprising a paint composition, wherein the roofing granule includes a percentage of sodium carbonate that is less than 1 wt % based on the total weight of the roofing granule.

In one embodiment, the base particles have been treated with carbon dioxide gas, as discussed above. In an embodiment, the base particles are treated with carbon dioxide gas after the coating is applied onto the base particles.

In one embodiment, the base particles are sintered.

In one embodiment, the base particles are unsintered.

Another embodiment of this invention pertains to a roofing material (e.g., a roofing shingle) that includes roofing granules comprised of base particles, including the above-discussed painted or coated base materials. Base particles may be applied to the back surface or front surface, including the buttlap and/or headlap of the shingle. In an embodiment, the base particles applied to the back surface, buttlap and/or headlap of the shingle have different particle size distributions. The choice of particle size distribution selected for a shingle surface may be influenced by the balance of surface coverage, shingle weight, degree of flatness and impact resistance required. The shingle may be a single-layer shingle or a laminated shingle.

According to one embodiment, a roofing material is provided that comprises coated base particles, the coated base particles having a coating comprising a paint composition, wherein the coated base particles are at least one of (i) free of clay, (ii) free of magnesium chloride, or (iii) a combination of (i) and (ii).

According to another embodiment, a roofing material is provided that comprises coated base particles, the coated base particles having a coating comprising a paint composition, wherein the coated base particles include a percentage of sodium carbonate that is less than 1 wt % based on the total weight of the coated base particles.

In one embodiment, the coated base particles have been treated with carbon dioxide gas.

In one embodiment, the coated base particles are sintered.

In one embodiment, the coated base particles are unsintered.

Examples of a sheet that may be used to make the shingle are as follows. In particular, in an embodiment, the shingle may be formed from a fiberglass mat with an asphalt coating on both sides of the mat. In an embodiment, the shingle may be formed from organic felt or other types of base material, including synthetic mats or synthetic glass/hybrid mats having an appropriate coating. Non-limiting examples of coatings include asphalt and modified bituminous coatings based on atactic polypropylene (APP), styrene-butadiane-styrene (SBS), styrene-ethylene-butadiene-styrene (SEBS), amorphous polyalpha olefin (APAO), thermoplastic polyolefin (TPO), synthetic rubber or other asphaltic modifiers.

In an embodiment, two or more shingles are installed on a roof deck in a roofing system such that the shingles are in a row from left to right and the lateral edges of the shingles in the row are contiguous with each other so as to abut each other, i.e., their lateral edges are adjacent to one another. Each row represents a course and the shingles are applied in overlapping courses on the roof deck, wherein the buttlap portion of a subsequent course is placed on the headlap portion of a previous course. In an embodiment, the headlap portion of the shingle is at least as wide as the buttlap portion of the shingle so that when the shingles are installed on a roof deck in overlapping courses, the entire buttlap portion of a subsequent course has headlap beneath it. In an embodiment, an edge of the shingle has a plurality of dragon teeth with openings therebetween. In an embodiment of the laminated shingle, a backer strip is provided under the dragon teeth, with portions of the backer strip exposed through the openings between the dragon teeth. In an embodiment of the single layer shingle, when the shingle is installed on a roof deck, the dragon teeth of a second layer of shingles is placed on the headlap of a previously installed layer of shingles, such that portions of the headlap region are exposed through the openings between the dragon teeth.

One embodiment pertains to a roofing system comprising one or more shingles that comprise the base particles, including the painted or coated base particles discussed above.

In some embodiments, the invention relates to the method of applying the base particles, including the painted or coated base particles discussed above, to a roofing material (e.g., a roofing shingle). In some embodiments, the method includes application of the base particles to at least one of the back surface or front surface, including the buttlap or the headlap of the shingle. Manufacturing the shingle includes applying base particles to asphalt coated sheeting. The asphalt sheet is then pressed in a press roll unit, such that the base particles embed in the asphalt coating. The asphalt sheet is then cut to the desired shape on a machine line. In embodiments, the invention includes the method of making and/or treating the base particles, including the painted or coated base particles discussed above, and applying the base particles to a shingle as detailed herein.

In one embodiment, the base particles and/or agglomerated particles are not sintered before being used. In other words, the base particles are, without being sintered, used to make a roofing material such as a shingle or roll roofing. As used herein “sintering” is the process of compacting and forming a solid mass of material by heat or pressure without melting it to the point of liquefaction.

The choice of particle size distribution selected for a shingle may be influenced by the balance of surface coverage, shingle weight, degree of flatness and impact resistance required.

According to embodiments of the invention described herein, cured, weather stable, painted roofing granules are prepared for roofing applications. According to embodiments described herein, the methods of preparing the roofing granules and/or base particles of the invention result in lower fuel consumption and lower greenhouse gas emissions from firing, and can even absorb greenhouse gas upon absorption and reaction of the silicate-based paints with the carbon dioxide gas.

### D. EXAMPLES

Specific embodiments of the invention will now be demonstrated by reference to the following examples. It should be understood that these examples are disclosed by way of illustrating the invention and should not be taken in any way to limit the scope of the invention.

### Example 1

In this example, coated granules (after post-treatment with carbon dioxide gas), which were prepared according to embodiments described herein, were subjected to an alkalinity test. To conduct this test, the post-treated, coated granules were boiled in water for a certain amount of time, with the boiling water being titrated to a neutral pH. The amount of titrant that was needed to neutralize the boiling solution to a neutral pH is correlated with the amount of silicate (with a basic pH) that was liberated from the coating of the coated granules. The lower the alkalinity number or amount of titrant needed to neutralize the boiling solution, the less silicate that was removed, and, therefore, the more stable the coating of the coated granules is inferred to be. Three coated granule samples were tested in this example, which included (i) fired granules (coated granules produced according to traditional firing or sintering conditions (i.e., granules coated with a silicate-based paint that has been cured by mixing the silicate with clay and thereafter fired)), (ii) CO₂-treated granules (i.e., coated granules that were post-treated with CO₂ gas without any firing or sintering as described herein), and (iii) chloride-treated granules (coated granules produced according to traditional chloride treatment (i.e., post-treatment of coated granules with a metal chloride and salt) without firing or sintering). Table 1 below illustrates the results of this example by showing the alkalinity number of the three types of tested, coated granules.

TABLE 1

| | Alkalinity Number |
|---|---|
| Fired Granules | 18.6 |
| CO₂-Treated Granules | 16.0 |
| Chloride Treated Granules | 29.0 |

Thus, as shown in Table 1 above, the CO₂-treated granules (i.e., coated granules that were post-treated with CO₂ gas without any firing or sintering) had the lowest alkalinity number and, therefore, required the least amount of titrant to neutralize the boiling solution. This lower alkalinity number indicates that the CO₂-treated granules had less silicate that was removed, and, therefore, the CO₂-treated granules had a more stable coating of the tested coated granules.

By way of reference, below is a table, Table 2, showing the correspondence between US Mesh, Tyler Mesh, and the sieve opening size in inches and micrometers:

TABLE 2

| | |
|---|---|
| ISO Standard | Opening |

| | | |
|---|---|---|
| Sieve Size | inches (in) | Standard Mesh |

| | | | | |
|---|---|---|---|---|
| mm or μm as | approximate | | US | Tyler |
| indicated | equivalents | mm | Mesh | Mesh |

| | | | | | |
|---|---|---|---|---|---|
| 5.60 | mm | 0.2230 | 5.600 | 3.5 | 3.5 |
| 4.75 | mm | 0.1870 | 4.750 | 4 | 4 |
| 4.00 | mm | 0.1570 | 4.000 | 5 | 5 |
| 3.35 | mm | 0.1320 | 3.350 | 6 | 6 |
| 2.80 | mm | 0.1100 | 2.800 | 7 | 7 |
| 2.36 | mm | 0.0937 | 2.360 | 8 | 8 |
| 2.00 | mm | 0.0787 | 2.000 | 10 | 9 |
| 1.70 | mm | 0.0661 | 1.700 | 12 | 10 |
| 1.40 | mm | 0.0555 | 1.400 | 14 | 12 |
| 1.18 | mm | 0.0469 | 1.180 | 16 | 14 |
| 1.00 | mm | 0.0394 | 1.000 | 18 | 16 |
| 850 | μm | 0.0331 | 0.850 | 20 | 20 |
| 710 | μm | 0.0278 | 0.710 | 25 | 24 |
| 600 | μm | 0.0234 | 0.600 | 30 | 28 |
| 500 | μm | 0.0197 | 0.500 | 35 | 32 |
| 425 | μm | 0.0165 | 0.425 | 40 | 35 |
| 355 | μm | 0.0139 | 0.355 | 45 | 42 |
| 300 | μm | 0.0117 | 0.300 | 50 | 48 |
| 250 | μm | 0.0098 | 0.250 | 60 | 60 |
| 212 | μm | 0.0083 | 0.212 | 70 | 65 |
| 180 | μm | 0.0070 | 0.180 | 80 | 80 |
| 150 | μm | 0.0059 | 0.150 | 100 | 100 |
| 125 | μm | 0.0049 | 0.125 | 120 | 115 |
| 106 | μm | 0.0041 | 0.106 | 140 | 150 |
| 90 | μm | 0.0035 | 0.090 | 170 | 170 |
| 75 | μm | 0.0029 | 0.075 | 200 | 200 |
| 63 | μm | 0.0025 | 0.063 | 230 | 250 |
| 53 | μm | 0.0021 | 0.053 | 270 | 270 |
| 45 | μm | 0.0017 | 0.045 | 325 | 325 |
| 38 | μm | 0.0015 | 0.038 | 400 | 400 |
| 32 | μm | 0.0012 | 0.032 | 450 | |
| 25 | μm | 0.0010 | 0.025 | 500 | |
| 20 | μm | 0.0008 | 0.020 | 635 | |

As discussed above, one example of rock and/or mineral is basalt; however, metabasalt (which is an amphibolite produced from the metamorphism of the basalt parent) may be used in addition to or instead of basalt. In other words, where the embodiments use the term basalt, they should be read as describing the use of basalt, metabasalt, or a combination of basalt and metabasalt.

Although the invention has been described in certain specific exemplary embodiments, many additional modifications and variations would be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

1. A method comprising:
obtaining base particles;
applying a paint composition to the base particles to produce painted base particles; and
treating the painted base particles with carbon dioxide gas.

2. The method according to claim 1, wherein the base particles comprise ceramic particles, mineral particles, rock particles, synthetic particles, agglomerated particles, or a combination thereof.

3. The method according to claim 1, wherein the treating of the painted base particles with carbon dioxide gas comprises placing the painted base particles in a chamber having a greater than atmospheric level of carbon dioxide gas.

4. The method according to claim 3, wherein the greater than atmospheric level of carbon dioxide gas is from 5% to 100% by volume based on a total volume of the chamber.

5. The method according to claim 1, wherein the treating of the painted base particles with carbon dioxide gas extends for a time period of from 1 minute to 120 minutes.

6. The method according to claim 1, wherein the paint composition comprises water, one or more pigments, and sodium silicate.

7. The method according to claim 1, wherein the paint composition is free of clay.

8. The method according to claim 1, wherein the paint composition is free of magnesium chloride.

9. The method according to claim 1, wherein the applying of the paint composition to the base particles is conducted at a temperature of 20° F. or less.

10. A roofing granule comprising:
one or more base particles; and
a coating applied onto the one or more base particles, the coating comprising a paint composition,
wherein the roofing granule is at least one of (i) free of clay, (ii) free of magnesium chloride, or (iii) a combination of (i) and (ii).

11. The roofing granule according to claim 10, wherein the roofing granule includes a percentage of sodium carbonate that is less than 1 wt % based on a total weight of the roofing granule.

12. The roofing granule according to claim 10, wherein the base particles comprise ceramic particles, mineral particles, rock particles, synthetic particles, agglomerated particles, or a combination thereof.

13. The roofing granule according to claim 10, wherein the base particles are treated with carbon dioxide gas after the coating is applied onto the base particles.

14. The roofing granule according to claim 10, wherein a binder is present in an amount of 1 wt % to 15 wt % with respect to a total weight of the base particles.

15. The roofing granule according to claim 10, wherein the base particles comprise agglomerated particles that comprise at least one of a rock, a mineral, or a combination thereof.

16. The roofing granule according to claim 10, wherein the paint composition comprises water, one or more pigments, and sodium silicate.

17. A roofing material comprising coated base particles, the coated base particles having a coating comprising a paint composition, wherein the coated base particles include a percentage of sodium carbonate that is less than 1 wt % based on a total weight of the coated base particles.

18. The roofing material according to claim 17, wherein the coated base particles comprise ceramic particles, mineral particles, rock particles, synthetic particles, agglomerated particles, or a combination thereof.

19. The roofing material according to claim 17, wherein the roofing material comprises a roofing shingle or roll roofing.

20. The roofing material according to claim 17, wherein the coated base particles have been treated with carbon dioxide gas.
